(19) United States
(12) Patent Application Publication
(10) Pub. No.: US 2005/0288045 A1
(43) Pub. Date: Dec. 29, 2005

(54) Apparatus, and an associated method, for forming direct data connection between applications of a set of mobile stations

(76) Inventors: Jianhao Michael Yang, San Diego, CA (US); Kuldeep Jain, San Diego, CA (US); Li Li, San Diego, CA (US)

Correspondence Address: SCHEEF & STONE, L.L.P., 5956 SHERRY LANE, SUITE 1400, DALLAS, TX, 75225, US

(21) Appl. No.: 10/880,326

(22) Filed: Jun. 28, 2004

(51) Int. Cl. H04Q 7/20

(52) U.S. Cl. 455/466

(57) ABSTRACT

Apparatus, and associated method, forms a direct data connection between mobile stations of a packet radio communication system. An SMS message is sent by an initiating mobile station to another mobile station between which communications are to be effectuated. The SMS message includes the IP address of the initiating mobile station. Once the SMS message is delivered to the other mobile station, the other mobile station is caused to obtain an IP address, if necessary. And, a socket connection is formed when the other mobile station returns a response message to the initiating mobile station. The mobile stations are each provided with the IP address of the other mobile station, and other needed information by way of which to form a direct connection upon which the data is communicated directly between the mobile stations.

The present invention relates generally to a manner by which to facilitate formation of a direct connection between mobile stations of a cellular, or other, radio communication system, thereby to facilitate communication of packet-formatted data directly between applications installed at the mobile stations. More particularly, the present invention relates to apparatus, and an associated method, by which to form a direct application-to-application connection between applications installed at the mobile stations and selectably to communicate the data therebetween.

More efficient and, hence, quicker communication of data between the mobile stations is provided. Applications, such as interactive games and instant messaging services, are enhanced as data, once a direct connection is established, is communicated directly between the applications at the respective mobile stations, not by way of a network device, such as a session interface protocol (SIP) server. Existing network infrastructure of conventional radio communication systems need not be altered to permit communications to be effectuated.

### BACKGROUND OF THE INVENTION

Operation of a communication system provides for the communication of data between communication stations of a set of communication stations. At least one of the communication stations of the set forms a sending station from which data is communicated. And, at least another of the communication stations of the set forms a receiving station to which the data is communicated. The sending and receiving stations of the set of communication stations are interconnected by way of a communication channel. Data sent by the sending station is communicated upon the communication channel to be delivered to the receiving station. The data, if necessary, is converted into a form at the sending station to permit its communication upon the communication channel, and the receiving station operates upon the detected data to recover the informational content thereof.

Many varied types of communication systems have been developed and are regularly used to effectuate different types of communication services. With continued advancements in communication technologies, yet additional types of communication systems, as well as improvements to existing types of communication systems, shall likely be developed and deployed.

A radio communication system is an exemplary type of communication system. In a radio communication system, the communication channel that interconnects the sending and receiving stations upon which the data is communicated therebetween is formed of a radio channel, defined upon a portion of the electromagnetic spectrum. In contrast, wireline communication systems require the use of wireline, i.e., electrical connections to be formed between the sending and receiving stations upon which to define the communication channels by way of which the data is communicated. When radio channels are utilized upon which to communicate data between the sending and receiving stations, the need otherwise to provide the wireline connections to interconnect the communication stations is obviated. Free of the need to utilize the wireline connections, radio communication systems permit communications to be effectuated between communication stations positioned at locations between which the formation of wireline connections, and use of a wireline communication system, would be impractical. Additionally, a radio communication system is amenable for implementation as a mobile communication system in which one or more of the communication stations between which data is communicated is permitted mobility.

A cellular communication system is a type of radio communication system. Telephonic communication of both voice and data is provided by a cellular communication system. The networks of various constructions of cellular communication systems are installed to provide cellular coverage that encompasses significant portions of the populated areas of the world. Portable radio transceivers, referred to as mobile stations, are typically used through which to communicate in a cellular communication system. That is to say, the mobile station communicates with fixed-site radio transceivers of the network of a cellular communication system. Communications are generally effectuable between a mobile station and a fixed-site transceiver in whose proximity that the mobile station is positioned.

While first-implemented cellular communication systems provided only limited data communication capabilities, subsequent generations of the cellular communication systems have provided increased data communication capabilities permitting increasingly data-intensive communication services to be effectuated therethrough.

Modern-generation, cellular communication systems generally provide for the communication of packet-formatted data pursuant to the effectuation of the data communication services. Various packet data protocols have been standardized, of which the IP (Internet protocol) protocol is amongst the most widely used protocols. In the IP protocol, as well as various others, digitized data is formatted into data packets that include both a header portion and a payload portion. The header portion includes various routing, and other, information, and the payload portion is populated with the data that is to be communicated, i.e., the informational content that is to be communicated through the communication of the data packet.

In some data communication services, data packets are communicated between the mobile station and a network-based device, such as a computer server that sources data that is to be sent to the mobile station. Two, or more, mobile stations sometimes also form the endpoints of a data communication service. That is to say, the data packets originated at one of the mobile stations are communicated, by way of the network to the other of the mobile stations. Conventional mechanisms by way of which to communicate the data between the mobile stations utilize some type of coordination at the network, such as through use of some type of network-based server. The network coordination is conventionally required for the reason that mobile stations do not maintain static, i.e., permanent, IP addresses to identify the mobile stations. Mobile-IP protocols, variants of the conventional IP protocol, also do not utilize permanent assignations of IP addresses to the mobile stations. Only the phone numbers assigned to the mobile stations are permanent at the mobile stations. IP connections are, therefore, unable to be initiated with another mobile station without the appropriate coordination, such as through use of a server, at the network.

Other mechanisms have also been proposed or specified. An interim standard, IS835c, promulgated by the EIA/TIA, sets forth an IP reachability service. Host names are used in this interim standard. But, again, a direct IP connection cannot be formed between mobile stations. And, the 3GPP (third generation partnership project) also specifies person-to-person IP connections. But, SIP signaling is used, necessitating SIP servers.

Some existing applications, such as interactive games or instant messaging, would be more efficiently effectuated if direct mobile station-to-mobile station IP connections could be formed to communicate data directly therebetween.

If a manner could be provided by which to provide an application-to-application IP connection between mobile stations, without necessitating new network mechanisms, improved communications would be possible.

It is in light of this background information related to packet radio communication systems that the significant improvements of the present invention have evolved.

### SUMMARY OF THE INVENTION

The present invention, accordingly, advantageously provides apparatus, and an associated method, by which to facilitate formation of a direct connection between mobile stations of a cellular, or other, radio communication system. Upon formation of the direct connection, communication of packet-formatted data directly between applications installed at the mobile station is facilitated. The direct connection is formed without the need of alteration to existing network infrastructure of the radio communication system.

Through operation of an embodiment of the present invention, a manner is provided by which to form a direct application-to-application connection between applications installed at the mobile stations and, once formed, to communicate the data therebetween. Because direct connections are formed between the applications of the mobile stations, more efficient and, thereby, quicker communication of data between the mobile stations results.

Any application in which increased speed of communication of data between the mobile stations would be beneficial benefit through operation of an embodiment of the present invention. Applications such as, for example, interactive gaming and instant messaging services are enhanced through operation of an embodiment of the present invention as data, once a direct connection is established between the mobile stations, is communicated directly between the applications at the respective mobile stations. The need otherwise to coordinate communications, once the direct connection has been established, by a network-based device, such as an SIP, or other, server, is obviated.

In one aspect of the present invention, IP (Internet protocol) formatted data packets are communicated pursuant to data communications between the mobile stations once a direct connection has been established. Each of the mobile stations is identified with a temporary IP address obtained, for instance, pursuant to PPP (point-to-point) setup procedures. The IP addresses are used to route the data packets to their respective destinations, i.e., the mobile stations. Because the IP addresses are only temporary identifiers, prior to the establishment of the direct connection between the mobile stations, the IP addresses must be obtained by the respective mobile stations. A mobile station that initiates the communications first obtains its IP address through performance of the PPPsetup procedures. The mobile station, for instance, obtains its IP address pursuant to a request to a PDSN (Packet Data Service Node) in whose area that the mobile station is positioned.

Once the IP address that is used to identify the initiating mobile station is provided to the initiating mobile station, the mobile station generates an initiation message that is to be sent to the other mobile station that is to be party to a communication session therebetween. An initiating mobile station is, for instance, an SMS (Short Message Service) message that identifies the other mobile station by a permanent identifier, e.g., the telephone number, of the other mobile station. Other initiating messages, identifying the other mobile station by a permanent identifier, are alternately utilized. The SMS, or other message, formed by the initiating mobile station includes the permanent identifier of the other mobile station and also includes an identification of the temporary IP address assigned to the initiating mobile station. The SMS, or other appropriate, message is routed by way of the short message service, or other appropriate routing center to route the message to the other mobile station.

When the message is delivered to the other mobile station, a temporary IP address is obtained, if needed, by the other mobile station. That is to say, if the other mobile station does not already have a temporary IP address assigned thereto, the IP address is requested and assigned thereto, such as pursuant to a point-to-point setup procedure. Once the temporary IP address is assigned to the other mobile station, the other mobile station forms a socket connection with the initiating mobile station thereby to form a direct connection with the initiating mobile station.

In a further aspect of the present invention, the initiation message generated by the initiating mobile station also identifies the port number associated with the mobile station. And, further, the initiation message also includes an identification of the application installed at the other mobile station between which the data communications are to be effectuated.

Once the mobile station sends the initiation message, the socket having the same port number as that contained in the initiation message is monitored. As the initiation message generated by the initiating mobile station identifies the port number to which the other mobile station should respond, monitoring of that port number ensures that the initiating mobile station shall detect delivery of the response to the initiating mobile station.

The initiating mobile station includes a timer that times-out for a selected time period. If the timer times-out, the initiating mobile station resends the initiating message and again monitors the socket associated with the port number identified in the resent initiation message. A counter is further utilized, if desired, to limit the number of times in which the initiating mobile station sends the initiation message.

In a further aspect of the present invention, prior to communication of the initiation message, a wake-up message is generated at the initiating mobile station and sent to the other mobile station. The wake-up message is, in the exemplary implementation, also an SMS message, or other appropriate message, that identifies the other mobile station with its permanent identifier. The wake-up message causes the other mobile station, when the other mobile station detects the SMS, or other appropriate, message set-up the point-to-point connection to obtain the IP address that temporarily identifies the other mobile station. In this implementation, the other mobile station returns an SMS message to the initiating mobile station. The other mobile station, in this implementation, in the SMS, or other appropriate, message, identifies the IP address assigned to the other mobile station, together with the port number to be used to form the socket connection. And, the initiating mobile station forms the socket connection as a response to return of the SMS, or other appropriate, message to the initiating mobile station. In this implementation, two SMS, or other, messages that utilize the permarient identifiers of the respective mobile stations are utilized.

In a further implementation, the multiple mobile stations, i.e., more than two mobile stations are connected by way of the direct connections to permit the packet data to be directly communicated therebetween, free of coordination by a network-based device once the connections are formed. Direct application-to-application communication of packet data between any of the multiple mobile stations is thereafter permitted. Increased efficiency of communications between any of the mobile stations between which the direct connections are formed is thereby provided.

In the exemplary implementation, a J2ME (Java 2 Micro Edition) application is installed at both the initiating mobile station and the other mobile station. The J2ME application forms, for instance, an instant messaging service or an interactive gaming service. When communications are to be effectuated, the initiating mobile station obtains an IP address to identify the initiating mobile station. And, an SMS message is formed that includes the IP address of the initiating mobile station together with a port number associated with a socket connection that is to be used pursuant to the communications. The SMS message is sent to the other mobile station by way of an SMS center. When the other mobile station receives the SMS message, the other mobile station also obtains, if needed, a temporary IP address that identifies the other mobile station, and a socket connection is initiated by the other mobile station. The socket connection forms the data connection by way of which the data is communicated pursuant to the effectuation of the communication service.

In these and other aspects, therefore, apparatus, and an associated method, is provided for a radio communication system. The radio communication system has a network part, a first mobile station, and at least a second mobile station and operates to communicate packet-formatted data. Formation of a direct packet connection between a first application installed at the first mobile station and a second application installed at the second mobile station is facilitated, thereby to permit packet data exchange directly between the first application and the second application installed at the first mobile station and the second mobile station, respectively. An initiation message generator is embodied at the first mobile station. The initiation message generator generates a connection-establishment initiation message for communication to the second mobile station by way of the network part. The connection-establishment initiation message includes a portion populated with an identification of the second application installed at the second mobile station. A response message detector is embodied at the first mobile station. The response message detector detects a response message returned to the first mobile station by the second mobile station responsive to delivery of the connection-establishment initiation message to the second mobile station. The response message is delivered to the first application installed at the first mobile station.

A more complete appreciation of the present invention and the scope thereof can be obtained from the accompanying drawings that are briefly summarized below, the following detailed description of the presently-preferred embodiments of the present invention, and the appended claims.

### BRIEF DESCRIPTION OF THE DRAWINGS

FIG. 1 illustrates a functional block diagram of a radio communication system in which an embodiment of the present invention is operable.

FIG. 2 illustrates a message sequence diagram representative of signaling generated during operation of an embodiment of the present invention.

FIG. 3 illustrates a message sequence diagram, similar to that shown in FIG. 2, but representative of operation of a further embodiment of the present invention.

FIG. 4 also illustrates a message sequence diagram, representative of a further embodiment of the present invention.

FIG. 5 illustrates a method flow diagram listing the method steps of the method of operation of an embodiment of the present invention.

### DETAILED DESCRIPTION

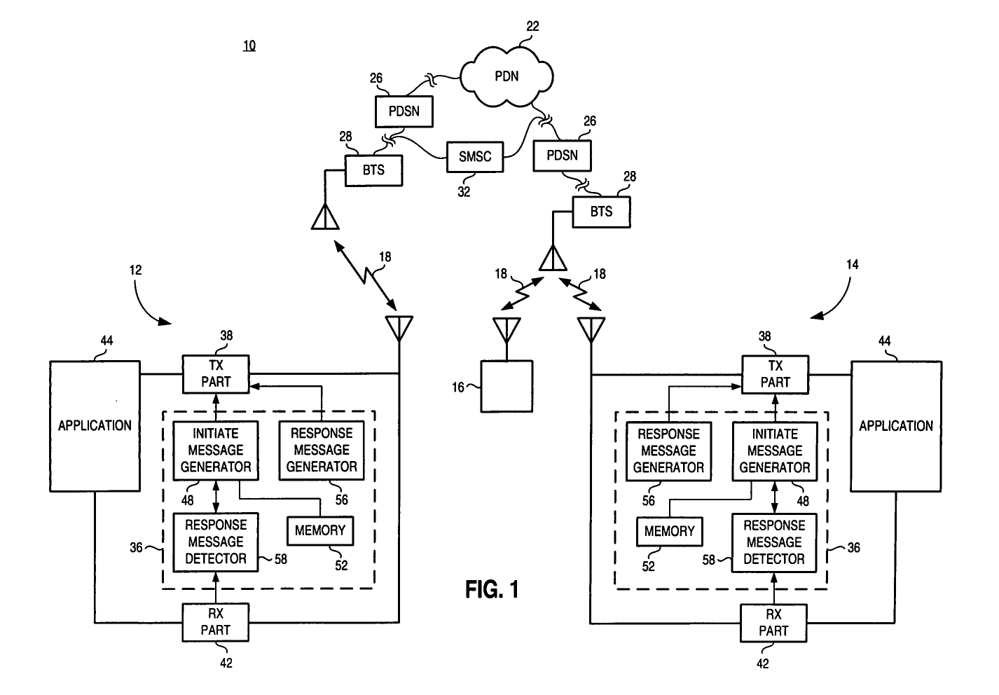

Referring first to FIG. 1, a packet radio communication system, shown generally at 10, provides for effectuation of communication services with mobile stations, of which the mobile stations 12, 14, and 16 are representative. In the exemplary implementation, the communication system forms a cellular communication system that provides for data services, such as instant messaging and interactive gaming. In other implementations, an embodiment of the present invention is implementable in other packet radio communication systems. And, the operation of such a radio communication system is analogously describable with respect to implementation of an embodiment of the present invention in such other type of radio communication system. Accordingly, the following description describes operation of the radio communication system and an embodiment of the present invention operable therein with respect to the radio communication system illustrated in the figure, the description is by way of example and not by way of limitation.

Communication of data is effectuated by, and with, the mobile stations 12, 14, and 16 upon radio channels defined upon a radio air interface extending between a network part of the communication system and the respective mobile stations. The arrows 18 are representative of the radio channels upon which the data is communicated between the network part and the respective ones of the mobile stations. Data communicated by a mobile station to the network part is referred to as being communicated upon a radio uplink channel, and data communicated by the network part to the mobile station is referred to as being communicated upon a radio downlink channel. Communications are effectuable, for instance, between sets of mobile stations, e.g., between the mobile stations 12 and 14 pursuant to effectuation of a data communication service. Data originated at the mobile station 12 is communicated by way of uplink channels to the network part, routed through the network part, and then communicated upon radio downlink channels to the mobile station 14. And, data originated at the mobile station 14 is communicated upon radio uplink channels to the network part, routed through the network part, and then communicated upon the radio downlink channels to the mobile station 12.

The network part includes a packet data network (PDN) 22. The packet data network includes, or is formed of, for instance, the Internet backbone. The network part also includes radio access network elements, here including packet data service nodes (PDSNs) 26, and base transceiver stations (BTSs) 28. Additional structure of the radio access network portions of the network part of the communication system are not separately shown, but are otherwise of conventional construction to provide for radio communications with mobile stations, such as the mobile stations 12, 14, and 16, pursuant to an appropriate operating specification, such as a cdma2000 operating specification.

Communication entities are connectable to the packet data network in conventional manner. And, an SMS (Short Message Service) center 32 is coupled to the base transceiver stations 28. The short message service center operates to route SMS messages that are generated during operation of the communication system. Short message service messages originated by a communication station, such as one of the mobile stations, is routed to the SMS center and, in turn, routed by the SMS center to its destination, such as another mobile station.

Data communication services utilizing IP-formatted data packets are effectuable between sets of communication stations, such as any combination of the mobile stations 12, 14, and 16. Conventionally, a network-based entity is required to coordinate the communication of the IP-formatted data. The need for such coordination increases the time period required to communicate the data packets. Generally, when the communication times required to communicate data packets between the communication stations that are parties to the communication are minimized, an improved communication experience, from the perspective of the users of the communication stations, is provided. Operation of an embodiment of the present invention facilitates an improved communication experience by obviating the need for the network coordination of the communication of the IP-formatted data through the formation of a direct connection between the communication stations that are parties to the communication session. Communication services such as instant messaging and interactive gaming are more efficiently carried out, in reduced amounts of time, through the communication of the data upon the direct connections formed between the communication stations.

A data communication service, for instance, is performed between applications installed at the mobile stations 12 and 14. In order to communicate data therebetween, the mobile station must be aware of the IP address that identifies the mobile station 14. And, conversely, the mobile station 14 must be aware of the IP address that identifies the mobile station 12 to communicate data packets thereto. In the communication system 10, the mobile stations, however, are not permanently identified with permanent IP addresses. But, rather, the mobile stations are identified with temporary IP addresses, and the mobile stations are provided with the temporary IP addresses by network entities with which the mobile stations are associated.

Pursuant to operation of an embodiment of the present invention, the temporary IP addresses are assigned to the mobile stations, essentially in conventional manner, such as e.g., formation of a point-to-point (PPP) connection between the mobile station and the associated packet data service node.

Initially, even once an initiating mobile station, here, e.g., the mobile station 12, obtains a temporary IP address to identify the mobile station, the IP address of the terminating mobile station, i.e., the other mobile station, here the mobile station 14, is unknown.

The mobile station 12 includes apparatus 36 of an embodiment of the present invention by which to facilitate the formation of the direct connection between the mobile station 12 and the terminating mobile station, here the mobile station 14. Others of the mobile stations also include the apparatus 36. The apparatus 36 is functionally represented and is formed of entities that are implementable in any desired manner, including algorithms executable by processing circuitry.

The mobile station also includes a transmit part 38 and a receive part 42. The apparatus 36 is coupled to both of the transmit and receive parts. Data is sourced and terminated at applications, such as the application 44, here functionally connected to the transmit and receive parts 38 and 42. The application is representative of any application, operation of which is performed pursuant to effectuation of a selected communication service. And, the application 44 is representative of, for instance, a J2ME (Java to Mobile Edition) and BREW (Binary Run-time Environment for Wireless application) including J2ME and BREW applications that are used pursuant to interactive gaming and instant messaging services.

The apparatus includes an initiation message generator 48 that forms an initiation message that is generated when a communication service is initiated by the mobile station. The initiation message is provided to the transmit part 38 and is caused to be communicated therefrom. The initiation message is, for example, an SMS message that is sent to the mobile station 14. An SMS message identifies a permanent identifier, such as the telephone number of the mobile station 14. An SMS message or analogous message that identifies the mobile station by a permanent identifier is communicated to the mobile station as, initially, the mobile station 12 is unaware of an IP address, if any, that identifies the mobile station 14. The telephone number, or other permanent identifier that identifies the mobile station, is here contained at a memory element 52 of the mobile station. And, the initiation message generator accesses the memory element to obtain the telephone number, or other permanent identifier, that identifies the mobile station 14. In the exemplary implementation in which the initiation message forms an SMS message, the SMS message is sent by way of an uplink channel on the radio link 18, routed through the network part of the communication system to the SMS center. The SMS center, in turn, forwards the SMS message to the mobile station 14.

The SMS message, once delivered to the mobile station 14, is used thereat to prompt the mobile station to obtain a temporary IP address, if a temporary address has not already been assigned to the mobile station. And, the mobile station 14 also includes apparatus 36 of an embodiment of the present invention. The mobile station 14 forms a peer device of the mobile station 12, and the apparatus 36 includes the entities just-described that form the apparatus 36 embodied at the mobile station 12. In addition to the entities analogous to those shown to form part of the apparatus embodied at the mobile station 12 that initiates the communication service, the apparatus 36 embodied at the terminating station includes a response message generator 56 that generates a response message responsive to the initiation message delivered thereto. The response message includes the IP address that is assigned to the mobile station 14. Because the IP address of the initiating mobile station is contained in the initiation message that is delivered to the mobile station 14, the response message is addressed to the IP address of the mobile station 12. The response message is routed back to the initiating mobile station 12. The mobile station 12 also includes the response message generator 56.

The apparatus 36 embodied at the initiating mobile station also includes a response message detector 58 coupled to the receive part 42 of the mobile station. The response message detector 58 detects delivery of the response message to the mobile station 12. Because the response message includes the IP address of the mobile station 14, the mobile station is thereby able to create a direct connection with the terminating mobile station and thereby data packets pursuant to the packet communication service are directly communicated therebetween, free of coordination by way of an entity of the network part. The apparatus 36 embodied at the mobile station 14 also includes a response message detector 58.

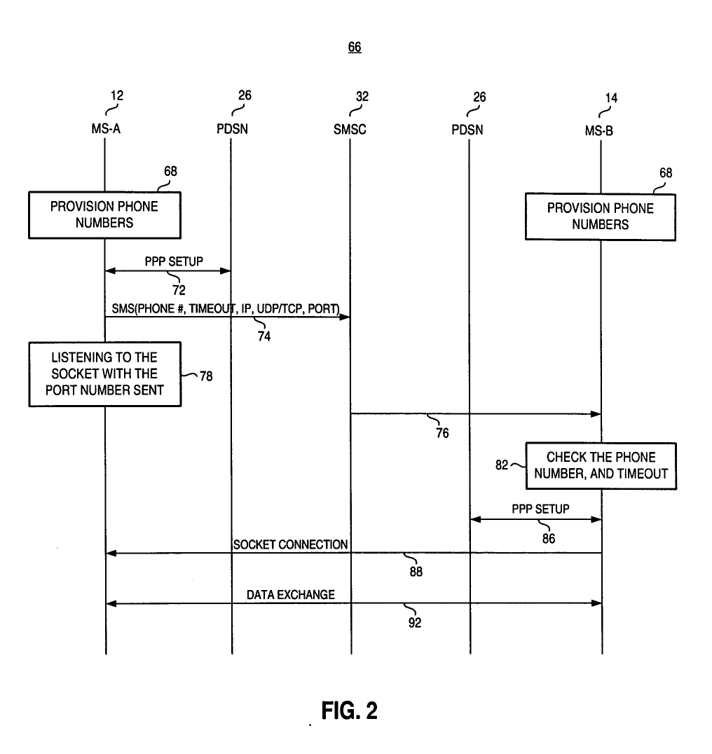

FIG. 2 illustrates a message sequence diagram, shown generally at 66, representative of signaling generated during exemplary operation of the communication system 10, shown in FIG. 1, pursuant to an embodiment of the present invention. The mobile station 12 forms the initiating mobile station and the mobile station 14 forms the other mobile station that is party to a communication session pursuant to which a communication service is effectuated. The packet data service nodes 26 and the SMS center 32 are also shown in the message sequence diagram.

Preliminary to operation, permanent phone numbers of the respective mobile stations are provisioned, indicated by the blocks 68 at the respective mobile stations. By preliminarily provisioning the respective mobile stations with the phone numbers of the other mobile stations, the phone numbers become trusted numbers, used to authenticate future IP connection requests.

Thereafter, and as indicated by the segment 72, PPP set-up procedures are carried out between the mobile station 12 and its associated packet data service node 26 to provide the mobile station 12 with an IP address to identify the mobile station. The IP address is provided to the mobile station 12. And, then, an SMS message is generated, indicated by the segment 74. The SMS message includes the telephone number of the other mobile station 14, the IP address of the mobile station 12, the port associated with the application associated with the communication service that is to be effectuated, the protocol, UDP or TCP (Uniform Data Protocol or Transport Control Protocol) and a time-out value. The SMS message is delivered to the SMS center 32. As the destination of the SMS message is not merely to the mobile station 14, but to a particular application installed in the mobile station, a unique identification should be included in the short message to distinguish the application in the mobile station 14.

Once delivered to the SMS center, the SMS center forwards on the SMS message, indicated by the segment 76, to the mobile station 14. The mobile station monitors the connection socket associated with the port number identified in the SMS message. Monitoring is indicated by the block 78. As there is no assurance that the other mobile station shall respond to the SMS message, a timer is also started at the initiating mobile station. When the timer times out, the initiating application at the mobile station attempts to retry the sending of the SMS message for a specific number of retransmissions. Each retransmission of the SMS message should be sent along with a new time stamp associated therewith. If after all of the retransmissions, no response is detected at the initiating mobile station, the application embodied at the mobile station at which the application stops monitoring the socket, and the network connection is torn down. The time stamp, i.e., the current time plus a time-out interval information, also forms part of the SMS message sent, indicated by the segments 74 and 76. Any selected retransmissions, including zero retransmissions are selectable.

At the block 82, the other mobile station receives the SMS message. Subsequent to lower-layer processing of an SMS header part of the SMS message, the SMS message is sent to a dispatch process that examines the unique identification in the SMS message and invokes the corresponding application. If the application is not installed at the other mobile station 14, the SMS message is discarded. If the application is installed at the other mobile station 14, the application is invoked. The application reads the SMS message and processes the message. The application retrieves the telephone number of the initiating mobile station from the body of the SMS message and determines with the preliminary provisioned phone numbers whether the telephone number is that of a trusted mobile station. If the number identifies a trusted mobile station, here a trusted peer device, then the application checks the time-out value that is contained in the SMS message. If the time-out value indicates that the timer at the initiating mobile station is already timed out, the application at the other mobile station takes no action.

Otherwise, the application at the mobile station 14 starts to make a network connection, here pursuant to a PPP set-up procedure shown at 86, to obtain an IP address for the mobile station. And, the mobile station 14 forms a socket connection, indicated by the segment 88, with the corresponding application of the initiating mobile station 12. Additional further security is implementable at the application level, if desired, to provide security in addition to the SMS security.

Once the socket connection has been established between the applications of the respective mobile stations, regular data exchange takes place, indicated by the segment 92.

Subsequent to establishment of the socket connection, if a retransmitted SMS message is detected at the other mobile station 12, this retransmitted SMS message is discarded. Additionally, in the event that an IP address changes during data exchange subsequent to formation of the socket connection, a new socket connection should be established for subsequent IP packet transportation. For instance, in an implementation using CDMA simple IP, if an IP connection between the mobile stations 12 and 14 enters into a dormant state and one of the mobile stations goes through an inter-PDSN handoff, its IP address changes before the application is terminated.

In such a scenario, if it is the other mobile station 14 that changes its IP address, the mobile station releases the previous socket connection and sends a new socket request to the initiating mobile station as the other mobile station 14 still knows of the IP address that identifies the initiating mobile station. If it is the initiating mobile station that changes its IP address, the initiating mobile station releases the previous socket, and sends a new SMS message to the other mobile station, and the steps 74, 76, 86, 88, and 92 are repeated. And, in a situation in which both of the IP addresses change, additionally, step 72 is carried out as a new SMS message must be sent to the other mobile station 14, and the application in the other mobile station shall re-establish the socket connection.

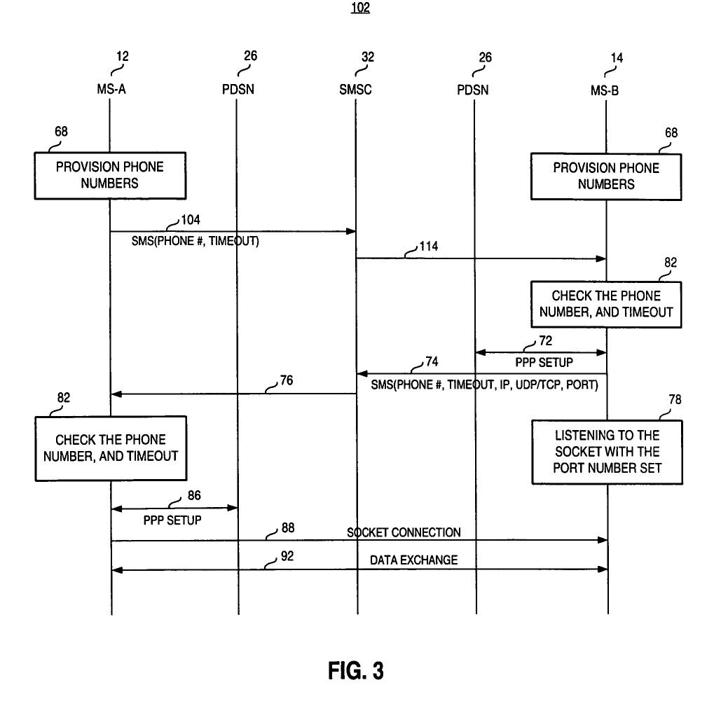

FIG. 3 illustrates another message sequence diagram, shown at 102, here representative of signaling generated pursuant to a further embodiment of the present invention. In this embodiment, an additional SMS message is generated. While an extra SMS message is used in the further embodiment represented by the diagram 102, in this embodiment, problems associated with delay in the event that the other mobile station fails to respond to the initiating SMS message are reduced. Here, the initiating mobile station first sends a wake-up SMS message, indicated by the segment 104. The SMS message is routed to the SMS center and, in turn, as indicated by the segment 114, to the other mobile station 14. In this implementation, the other mobile station first performs the point-to-point set-up procedure, indicated by the segment 72, obtains a temporary IP address to identify the mobile station, and sends an SMS message, indicated by the segments 74 and 76, to the initiating mobile station. And, the initiating mobile station obtains a temporary IP address, indicated pursuant to the PPP set-up procedure 86. Thereafter, the initiating mobile station forms the socket connection, indicated by the segment 88, and, thereafter, data is exchanged, indicated by the segment 92.

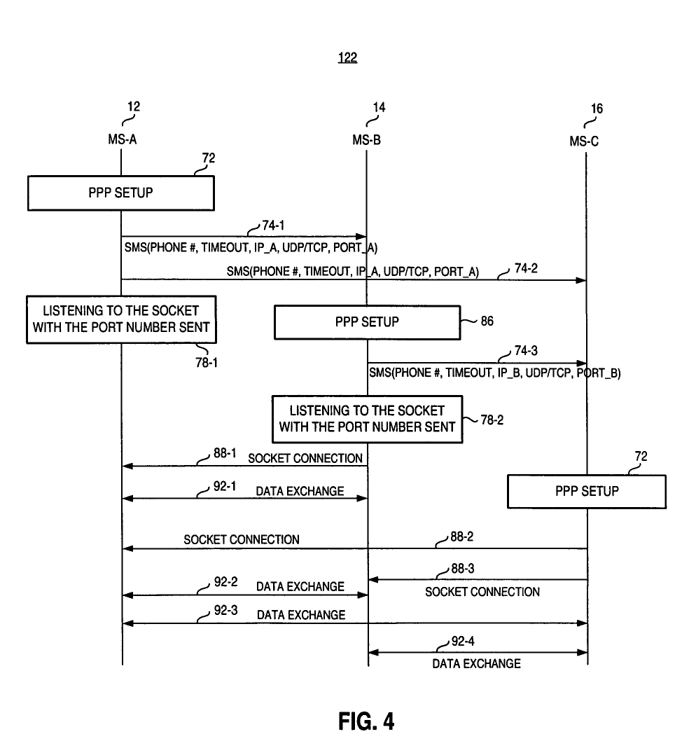

FIG. 4 illustrates a message sequence diagram, shown generally at 122, representative of a further implementation of an embodiment of the present invention. The sequence shown in FIG. 4 illustrates formation of direct connections between more than two mobile stations, here the mobile stations 12, 14, and 16. Here, again, the mobile station 12 forms the initiating mobile station. PPP set-up procedures are carried out by the initiating mobile station, again indicated at 72. Then, as indicated by the segments 74-1 and 74-2, SMS messages are sent to the other mobile stations. The SMS messages here also include the phone numbers of the mobile stations 14 and 16. Here, the other mobile station 14 first receives the SMS message and performs PPP set-up procedures, indicated at 86 to obtain an IP address. Once the IP address is obtained, the mobile station 14 sends an SMS message, indicated by the segment 74-3, to the mobile station 16. The SMS message represented by the segment 74-3 includes the phone number of the mobile station 16 as such number is provided to the mobile station 14 in the message 74-1. The mobile stations 12 and 14 listen to the socket with the port number contained in the SMS messages sent by the respective mobile stations. Listening is indicated at the blocks 78-1 and 78-2.

Socket connections are formed, indicated by the segments 88-1, 88-2, and 88-3. And, data is exchanged, indicated by the segments 92-1, 92-2, 92-3, and 92-4.

In this implementation, the applications at the mobile stations include mechanisms by which to synchronize the behaviors of the mobile stations 14 and 16 so that both of the mobile stations do not set up PPP connections and broadcast their respective IP addresses at the same time resulting in deadlock situations. In one implementation, the mechanism that is used forms a random back-off timer.

To provide additional levels of security of the SMS message that conveys the IP address of a mobile station, the source phone number of the initiating mobile station need not be provided by the application itself, but rather the lower layer inside the mobile station. An SMS message is not sent on behalf of another phone number. The phone number in an SMS message is considered to be authenticated when it arrives at another mobile station. Thereby, authentication is based upon the source phone number itself. It is also not necessary to encrypt the payload part of an SMS message as the path of the SMS message that travels between a set of mobile stations is within the private network of a carrier. A short message service center between two carriers usually exchanges SMS messages by way of a secure connection. Thereby, end-to-end encryption of the payload of the SMS message is not required.

An appropriate SMS message is selected to convey the IP address and other authentication information to a particular application in the other mobile station. Various alternatives are available.

In one implementation, a special tele-service identifier, such as that specified in the IS-637A standard is used. A low-layer change in the standard is required in order to accommodate the new tele-service ID.

In another implementation, a WAP (Wireless Access Protocol) push message format is utilized, e.g., the TLID is 4100 and the WDP port number is 2948. That is to say, this is the LANA port for a WAP push. Because the port number is the same for all of the WAP push message, an application ID in the WSP header is definable so that the WAP push message shall reach the dispatch process in the other mobile station. Within a WSP payload, the targeted MIDLET name, its version, and vendor are included along with the IP address, port number, and authentication information. This allows for the dispatch process to find the correct MIDLET.

In another implementation, USES MIDP2.0 push registry is used together with JSR120. The MIDLET chooses to use either static registration or dynamic registration to register a port number that the MIDLET listens to for the JSR120 SMS messages. In a static registration, the MIDLET specifies the port number by listing the MIDLET-PUSH attributes in the JAD file. In a dynamic registration procedure, the MIDLET registers the port number at run time using the push registry API. When a JSR120 SMS message with the registered port number is received, the corresponding MIDLET is launched automatically. In this implementation, when the mobile station is online, the IP address is available through the MIDP2.0 API.

In this procedure, the MIDLET registers a port number either statically or dynamically. After the MIDLET is started, the network connection is opened with the packet data service node and the IP address is obtained. The MIDLET then opens an SMS connection with the port number that the MIDLET in the other mobile station registers and sends an SMS message to the MIDLET in the other mobile station. The SMS message payload decision is left to the application. This can contain, for example, the text stream in the format of “phone number, time-out value, IP address, UDP or TCP, UDP or TCP port number.” Alternatively, an XML format is used. Both JRS120 and BREW provide API for an application to compose such kind of SMS message.

The PPP set-up procedure by way of which to obtain a temporary IP address is implemented, e.g., responsive to reception at the other mobile station of the SMS message. The dispatch process launches the correct MIDLET according to the port number. The MIDLET in the mobile station receives the SMS message and processes the message by checking if the SMS message comes from a trusted application and checks whether time-out has occurred. If the check passes, the MIDLET starts the socket connection with the MIDLET in the initiating mobile station.

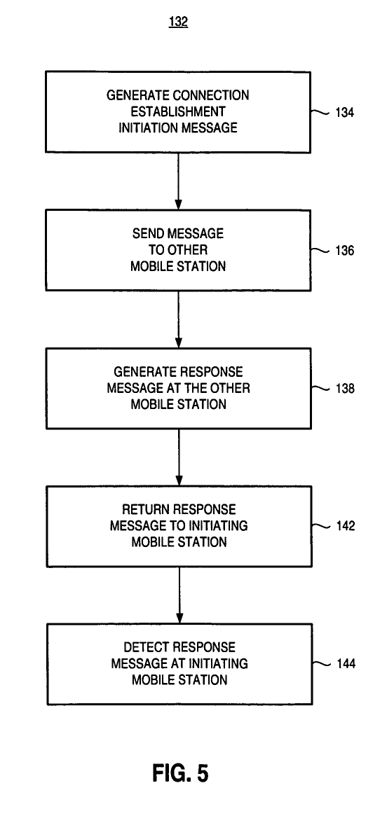

FIG. 5 illustrates a method flow diagram, shown generally at 132, representative of the method of operation of an embodiment of the present invention. The method facilitates formation of a direct packet connection between a first application installed at a first mobile station and a second application installed at a second mobile station, thereby to permit packet data exchange directly between the first and second applications.

First, and as indicated by the block 134, a connection establishment initiation message is generated for communication to the second mobile station by way of the network part of the radio communication system. The connection establishment initiation message includes a portion populated with an identification of the second application installed at the second mobile station.

Then, and as indicated by the block 136, the message is sent to the second mobile station. Thereafter, and as indicated by the block 138, a response message is generated at the second mobile station, and as indicated by the block 142, the response message is returned to the first mobile station.

Thereafter, and as indicated by the block 144, the response message is detected at the first mobile station responsive to delivery of the connection establishment message to the second mobile station.

Thereby, through operation of an embodiment of the present invention, an improved manner is provided by way of which to directly communicate IP-formatted data between mobile stations pursuant to a packet communication service. Direct connections are formed between the mobile stations without the need of new network devices or entities. Existing network infrastructure need not be altered in any manner to provide the direct connections that permit the data to be communicated directly between the mobile stations.

The previous descriptions are of preferred examples for implementing the invention, and the scope of the invention should not necessarily be limited by this description. The scope of the present invention is defined by the following claims.

1. In a radio communication system having a network part, a first mobile station and at least a second mobile station operable to communicate packet-formatted data, an improvement of apparatus for facilitating formation of a direct packet connection between a first application installed at the first mobile station and a second application installed at the second communication station, thereby to permit packet data exchange directly between the first application and the second application installed at the first mobile station and the second mobile station, respectively, said apparatus comprising:
an initiation message generator embodied at the first mobile station, said initiation message generator for generating a connection-establishment initiation message for communication to the second mobile station by way of the network part, the connection-establishment initiation message including a portion populated with an identification of the second application installed at the second mobile station;
a response message detector embodied at the first mobile station, said responsive message detector for detecting a response message returned to the first mobile station by the second mobile station responsive to delivery of the connection-establishment initiation message to the second mobile station, the response message delivered to the first application installed at the first mobile station.

2. The apparatus of claim 1 wherein the first mobile station is identified by a first permanent identifier, wherein the second mobile station is identified by a second permanent identifier, and wherein the connection-establishment initiation message generated by said initiation message generator includes the second permanent identifier, the network part, by way of which the connection-establishment initiation message is communicated, utilizing the second permanent identifier to route the connection-establishment initiation message to the second mobile station.

3. The apparatus of claim 2 wherein the radio communication system provides short message service communications and wherein the connection-establishment initiation message generated by said initiation generator comprises a short message service message, routable by way of the network part to the second mobile station.

4. The apparatus of claim 1 wherein the first mobile station is temporarily identifiable by a first temporary address, the establishment initiation message further including a further portion populated with an identification of the first temporary address by which the first mobile station is identified.

5. The apparatus of claim 4 wherein the second mobile station is temporarily identifiable by a second temporary address, the second mobile station at least identified with the second temporary address responsive to detection of delivery of the connection-establishment initiation message, and wherein the response message returned to the first mobile station for detection by said response message detector includes indications of the second temporary address therein.

6. The apparatus of claim 5 wherein the packet-formatted data comprises IP-formatted data, wherein the first temporary address comprises a first IP address, wherein the second temporary address comprises a second IP address, and wherein the response message returned to the first mobile station for detection by said response message detector includes indications of the second IP address therein.

7. The apparatus of claim 5 wherein the packet-formatted data comprises IP-formatted data, wherein the first temporary address comprises a first IP address, and wherein the further portion of the connection-establishment initiation message comprises identification of the first IP address.

8. The apparatus of claim 7 wherein the first application installed at the first mobile station is further identified by a port number and wherein the connection-establishment initiation message generated by said initiation message generator further contains an indication of the port number.

9. The apparatus of claim 8 further comprising a port selector for selecting the port number.

10. The apparatus of claim 9 wherein selection made of the port number by said port selector is made dynamically.

11. The apparatus of claim 8 wherein said response message detector monitors the port number identified in the connection-establishment initiation message to detect the response message returned to the first mobile station.

12. The apparatus of claim 1 wherein said initiation message generator is selectably operable to generate the connection-establishment initiation message at least a selected number of times in absence of detection by said response message detector of the response message.

13. The apparatus of claim 1 further comprising a wake-up message generator embodied at the first mobile station, said wake-up message generator for generating a wake-up message for communication, by way of the network part, to the second mobile station, and a wake-up response detector embodied at the first mobile station, said wake-up response detector for detecting a response returned, by way of the network part, from the second mobile station.

14. The apparatus of claim 13 wherein the radio communication system provides short message service communications and wherein the wake-up message generated by said wake-up generator and the response thereto detected by said wake-up response detector comprise short message service messages.

15. The apparatus of claim 1 further comprising a timer for timing-out a timed value according to a selected timing scheme and wherein the connection-establishment initiation message generated by said initiation message generator is generated responsive to timing out of said timer.

16. A method for facilitating formation of a direct packet connection between a first application installed at a first mobile station and a second application installed at a second mobile station of a radio communication system, thereby to permit packet data exchange directly between the first application and the second application, said method comprising the operations of:
generating a connection-establishment initiation message for communication to the second mobile station by way of a network part of the radio communication system, the connection-establishment initiation message including a portion populated with an identification of the second application installed at the second mobile station; and
detecting a response message returned to the first mobile station responsive to delivery of the connection-establishment message to the second mobile station, the response message delivered to the first application installed at the first mobile station.

17. The method of claim 16 further comprising the operations of:
sending the connection-establishment initiation message to the second mobile station;
generating the response message at the second mobile station; and
returning the response message to the first mobile station.

18. The method of claim 16 wherein the first mobile station is temporarily identifiable by a first temporary identifier, wherein the second mobile station is temporarily identifiable by a second temporary identifier, wherein the connection-establishment initiation message generated during said operation of generating further includes an identification of the first temporary identifier that identifies the first mobile station.

19. The method of claim 18 wherein the response message detected during said operation of detecting includes identification of the second temporary identifier that identifies the second mobile station.

20. The method of claim 19 further comprising the operation of communicating the packet data directly between the first application installed at the first mobile station and the second application installed at the second mobile station using the first and second temporary identifiers, respectively.
